(19) United States
(12) Patent Application Publication
(10) Pub. No.: US 2011/0276891 A1
(43) Pub. Date: Nov. 10, 2011

(54) VIRTUAL ART ENVIRONMENT

(76) Inventor: Marc Ecko, New York, NY (US)

(21) Appl. No.: 12/775,287

(22) Filed: May 6, 2010

(51) Int. Cl. G06F 3/01; G06F 3/033; G06F 17/30; G06F 3/048; G06F 15/16

(52) U.S. Cl. 715/739; 715/863; 715/771; 345/157

(57) ABSTRACT

Computer-based methods, systems, and apparatus, including computer programs encoded on a computer storage medium, for presenting a first virtual art canvas at a graphical user interface; receiving instructions from a remote control unit to apply one or more markings to the virtual art canvas, where the one or more markings are applied according to the remote control unit's movements relative to a stationary sensor; and displaying one or more indicators on the virtual canvas to guide a user's movement of the remote control unit to create a virtual piece of art on the first virtual art canvas based, at least in part, on movements of the remote control unit.

### BACKGROUND

This specification relates to a virtual art environment and, more particularly, to a computer-based virtual art environment.

Visual art work has existed for centuries and evolved over time in a variety of ways. Computers have opened the door to a variety of new ways that visual art work can be developed and shared.

### SUMMARY

This specification describes technologies relating to a virtual art environment.

In general, one innovative aspect of the subject matter described in this specification can be embodied in computer-based methods that include the actions of: presenting a first virtual art canvas at a user interface; receiving instructions from a remote control unit to apply one or more markings to the virtual art canvas, where the one or more markings are applied according to the remote control unit's movements relative to a stationary sensor; displaying one or more indicators on the virtual canvas to guide the user's movement of the remote control unit to create a virtual piece of art on the first virtual art canvas based, at least in part, on movements of the remote control unit.

These and other embodiments can each optionally include one or more of the following features.

The computer-based method can include requiring the user to manipulate the remote control unit in a manner that mimics the movements that would be required if the user were applying non-virtual art medium to a non-virtual art canvas to create a non-virtual piece of art that corresponds to the virtual piece of art. The computer-based method can include revealing discrete sections of the one or more indicators in a sequential manner as one or more of the markings are applied to the virtual canvas at locations that correspond to one or more of the previously-revealed indicators.

In some implementations, the computer-based method includes automatically assessing, with a computer processing unit, a quality of the one or more markings applied to the virtual canvas based on one or more of the following criteria: how closely the movements of the remote control and application of the one or more markings correspond to the one or more indicators; and how quickly the applied markings have been applied. An indication of the assessed quality can be presented at the user interface.

According to certain embodiments, the one or more indicators are revealed on the virtual canvas in a manner that guides the user to create the virtual piece of art work in a series of discrete stages. Each discrete stage corresponds to a particular aspect of the virtual piece of art work.

Upon completion of each discrete stage, in some implementations, a visual representation of the completed stages is presented on the virtual canvas, and the physical appearance (including the quality of the physical appearance) of each visually represented stage corresponds to an assessed quality of the applied markings in the stage.

A virtual medium (e.g., virtual paint from a virtual paint can) typically is used to apply the one or more markings and wherein a supply of the virtual medium gradually becomes depleted or otherwise compromised as the one or more markings are applied.

In some implementations, the method includes enabling a user to replenish or otherwise restore the supply of virtual medium by manipulating the remote control unit (e.g., by shaking it like a depleted can of spray paint) so that markings can continue being applied to the virtual canvas.

Some implementations include presenting on the user interface a real-time visual indication of the degree to which the virtual medium being applied to create the one or more markings has been depleted or otherwise compromised. The visual indication may be a schematic representation of a spray paint can, for example, showing a paint level that lessens over time as the virtual markings are applied and that increases whenever the user, for example, physically shakes the can-style controller.

Certain embodiments include storing one or more virtual pieces of art in an electronic database; and enabling the user to access the electronic database over a network and to select among the stored virtual pieces of art one of the virtual pieces of art to create.

The remote control unit can be shaped substantially like a spray paint can and have a nozzle at a top of the can that can be depressed to apply the one or more markings to the virtual canvas as a virtual spray paint.

In some embodiments, the spray pattern thickness associated with the one or more markings is related to the remote control unit's distance from the stationary sensor as the one or more markings are being applied to the virtual canvas, wherein a greater distance produces a wider pattern; and a closer distance produces a narrower pattern.

Certain implementations include creating an appearance of dripping paint on the virtual canvas in response to a user applying an amount of the virtual spray paint to a location on the virtual canvas that exceeds a predetermined threshold amount.

In some implementations, the computer-based method includes presenting a second virtual art canvas at the user interface, receiving instructions from the remote control unit to apply one or more markings to the second virtual art canvas, wherein the one or more markings are applied according to the remote control unit's movements relative to the stationary sensor; and enabling the user to create an original piece of virtual art work without the guidance of indicators being displayed on the second virtual canvas as the original piece of virtual art work is being created.

According to some embodiments, the computer-based method includes: enabling the user to upload the original piece of virtual art work to an electronic database over a network; and enabling users at different physical locations to access the electronic database and view the original piece of art work.

The computer-based method typically includes creating a map of indicators based on the original piece of virtual art work. The map of indicators relate to original piece of virtual art work in such a manner that the indicators can guide other users to create substantial copies of the original piece of virtual art work.

In some instances, the computer-based method includes enabling users at different physical locations to access the electronic database and select the original piece of art work from the electronic database. Selecting the original piece of virtual art work can cause the mapped indicators to be presented at the a selecting user's user interface in such a manner that the selecting user is guided by the mapped indicators to create a copy of the original piece of virtual art work on a virtual art canvas.

In another aspect, a computer-based method includes presenting a virtual art canvas at a user interface; receiving instructions from a remote control unit to apply one or more markings to the virtual art canvas and thereby create an original piece of virtual art work on the virtual art canvas, wherein the one or more markings are applied according to the remote control unit's movements relative to a stationary sensor; creating a map of indicators based on the original piece of virtual art work; and enabling users at different physical locations to be guided by the mapped indicators to create a copy of the original piece of virtual art work.

Included within the scope of this disclosure are modifications of the methods and systems disclosed herein as well as methods relating to the use and operation of the system, and articles comprising a machine-readable medium that stores machine-executable instructions for causing a machine (e.g., a computer) to implement aspects of the methods.

In general, another aspect of the subject matter described in this specification can be embodied in computer-based methods that include the actions of: presenting a virtual art canvas at a user interface; receiving instructions from a remote control unit to apply one or more markings to the virtual art canvas and thereby create an original piece of virtual art work on the virtual art canvas, where the one or more markings are applied according to the remote control unit's movements relative to a stationary sensor; creating a map of indicators based on the original piece of virtual art work; and enabling users at different physical locations to be guided by the mapped indicators to create a copy of the original piece of virtual art work.

Other embodiments of this aspect include corresponding systems, apparatus, and computer programs, configured to perform the actions of the methods, encoded on computer storage devices.

Particular embodiments of the subject matter described in this specification can be implemented so as to realize one or more of the following advantages. For example, a user can experience a very realistic simulation of creating a non-virtual piece of art work (e.g., graffiti-based art work). Moreover, the user receives guidance to create copies of existing art work, which can help hone the user's artistic abilities. Additionally, users can share their art work with others, see and copy the art work of others and use the social networking capabilities of the system disclosed to develop a notoriety in the virtual and non-virtual art world.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a perspective view of a user interacting with a virtual art environment.

FIGS. 2-10 are screen shots showing various aspects of the virtual art environment.

FIGS. 11A and 11B are front and rear views of an exemplary hand-held spray paint can styled controller.

FIG. 12 is a schematic diagram of a computer system adapted to implement various aspects of a virtual art environment.

Like reference numbers and designations in the various drawings indicate like elements.

### DETAILED DESCRIPTION OF THE DRAWINGS

The present disclosure relates to a virtual art environment and, more particularly, relates to a computer-based virtual art environment in which users can create original art work, receive guidance to create copies of existing art work created by others, be scored based on speed and accuracy in creating art work, share the art work they create or copy with others over a computer network (e.g., the Internet).

To create or copy art work in the virtual environment, a user manipulates an electronic controller in a manner that substantially mimics the movements that would be required to create a comparable piece of art work in a non-virtual environment (e.g., to create graffiti on a wall of a building). In various implementations, the user receives guidance in attempting to copy certain art work. By creating or copying art work, users can hone their virtual and real-world artistic skills within the virtual environment.

The virtual art environment also includes social aspects in that it provides for a virtual marketplace/art gallery in which users at different physical locations can display their art work and share it with others. Users also can download the art work of others for pleasure, for copying or for use as a source of inspiration. Typically, when a user downloads the art work of another for copying purposes, the copying user receives guidance in the virtual environment as to how to create the copy. It is expected that some artists displaying and disseminating their original works of virtual art through the virtual marketplace/art gallery may achieve some degree of artistic notoriety in the virtual art community and beyond.

In some embodiments, the virtual marketplace/art gallery enables users to exchange currency (virtual or real) in transactions that involve the exchange of virtual art work. Thus, it is envisioned that, at least in some instances, the ability to exchange currency may create further incentives for potential artists to develop their artistic abilities and artistic personas.

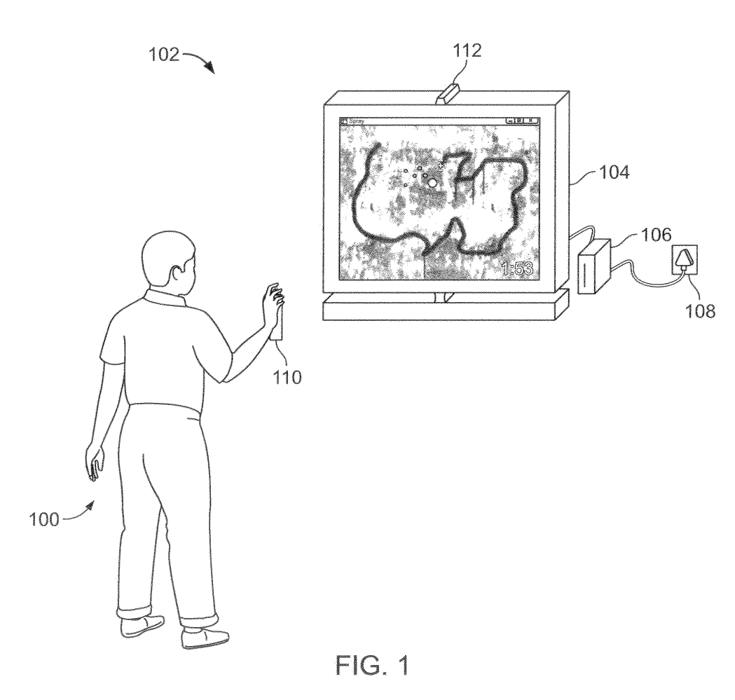

FIG. 1 is a perspective view showing a person 100 and various components of a computer system 102 that creates a virtual art environment and enables the user to interact within that environment. In a typical implementation, the illustrated components would be present in the person's home.

The illustrated components include a user interface 104 (e.g., a television set), a home video game console 106 connected to the user interface 104 and to the Internet (at Internet access point 108), a hand-held controller 110 that the user can manipulate and a position sensor 112 above the user interface for sensing the position of the controller 110.

The controller 110 typically includes a data entry device, a communications module, provisions that enable the position sensor 112 to determine the controller's position.

The data entry device typically enables a user to enter data, such as commands and the like, into the system 102. Examples include one or more buttons, a joystick, a trackball, a microphone, and/or a touch screen.

The communications modules can include, for example, a short range radio that utilizes Bluetooth™ technology to communicate with the game console. In other implementations, the communications module can be adapted to implement other wireless or hard-wired communications techniques.

In some implementations, the controller 110 includes an accelerometer and two or more infrared light emitting diodes (LEDs) or groups of LEDs. In these implementations, the position sensor 112 includes an infrared detector that detects the infrared light emitted by the light emitting diodes. This information, sometimes in connection with information from the accelerometers, enable the system to determine the position of the controller, relative to the position sensor 112, substantially in real time.

In a typical implementation, the controller 110 either is substantially shaped like an art medium delivery device (e.g., a can of spray paint, a paint brush, a pencil, etc.) or is coupled to an adapter that is substantially shaped like an art medium delivery device.

The game console 106 typically is adapted to receive a portable computer readable medium, such as a computer disc. The disc can include computer-readable instructions that, when executed, causes the game console and/or the other components described herein to perform the various functions described.

In an exemplary implementation, the game console 106 is the console for the Wii™ system, available from Nintendo Co., Ltd. of Kyoto, Japan, the position sensor 112 is one of the wireless controllers from the Wii™ system, and the hand-held controller 110 is a second one of the wireless controllers from the Wii™ system coupled to an adapter that includes at least two infrared LEDs.

During operation, data from the hand-held controller 110 is transmitted wirelessly, via Bluetooth™ technology to the game console 106. This data can include, for example, instructions from the user or information related to the controller's movement derived from the controller's internal accelerometer.

The LEDs on the hand held controller 110 continuously transmit infrared light towards the infrared detector on position sensor 112. The position sensor 112 communicates with the game console 106 using Bluetooth™ technology.

In a typical implementation, there are at least two LEDs on the hand held controller 110 that are separated from each other by some distance. For example, in one implementation, one or more LEDs are arranged near the top of the controller 110 and one or more LEDs are arranged near the bottom of the controller 110. The light emitted from each end of the controller 110 is focused onto the infrared detector which sees the light as two bright dots separated by a distance. Since the actual distance between the two clusters of LEDs on the controller is a fixed distance, the distance between the controller 110 and the position sensor 112 using triangulation. Rotation of the controller 110 with respect to the ground also can be calculated from the relative angle of the two dots of light on the infrared detector. Moreover, the accelerometer inside the controller 110 can provide data that indicates when the remote is moving, up, down, left right, forward backward, is pitching or rolling.

In a typical embodiment, the game console 106 includes a processor that processes the data it receives from the hand-held controller 110, the position sensor 112 and/or the Internet and creates a virtual art environment at the user interface 104 as detailed herein.

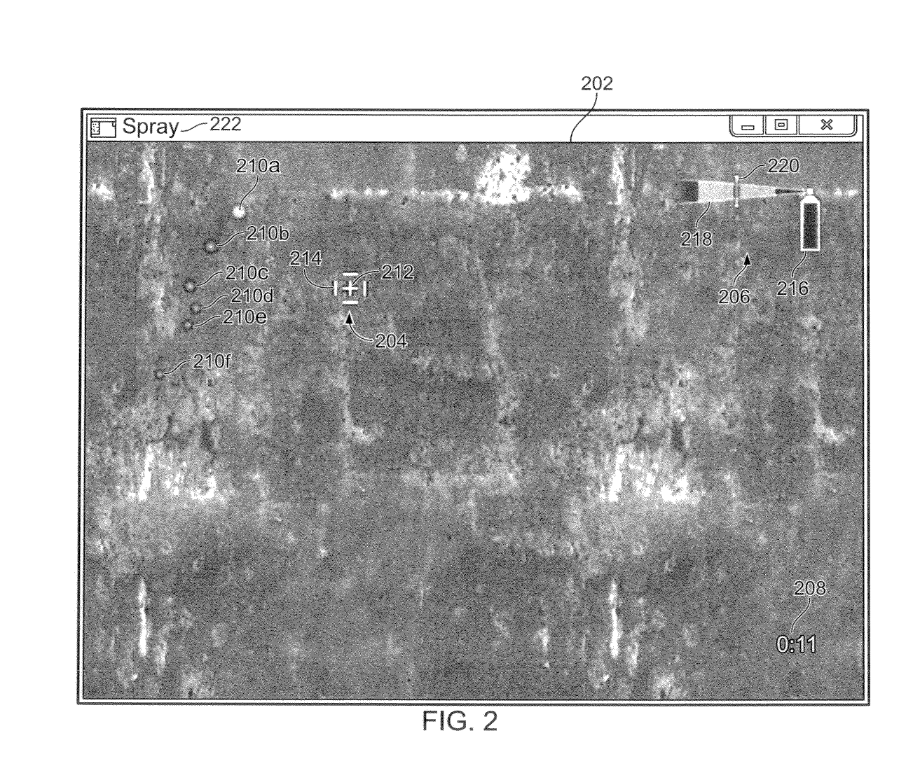

FIGS. 2-10 are exemplary screenshots from user interface 104 showing a virtual canvas upon which a user can create virtual art work and various aspects of the virtual art environment.

The system 102 typically provides for at least two art creation modes: a guided-mode, in which a user can receive guidance in creating a copy of existing art work; and free-style mode, in which the user can utilize the various tools provided to create original art work without guidance from the system. In some implementations, free-style mode gives users to option incorporate existing art work, or certain aspects of existing art work, into their own original art work.

FIGS. 2-7 show an exemplary series of screen shots that would appear to the user at user interface 104 in guided-mode. In the illustrated example, the user is guided to create a copy of existing graffiti-style art work by applying a virtual art medium (e.g., virtual spray paint) on a virtual canvas that has the appearance of a concrete wall.

In guided-mode, the existing art work to be copied can be, for example, a work that was previously created by the user, a work that was created by another system user, or a work, such as famous art work, that is available in the public domain. It may have been downloaded from the Internet or loaded from a disc or other computer-based memory storage device.

FIG. 2 is an initial screen shot showing the virtual art canvas 202, a cursor 204 that can move across the virtual art canvas 202 according to a user's movements of hand-held controller 104 and a series of guidance indicators 210a-210f to help guide the user's movements of the controller 104 to create a copy of existing graffiti-style art work. The screen shot also includes a spray paint can icon 206 in the upper right corner of the screen and a timer 208 in the lower right corner of the screen.

In the illustrated implementation, the movable cursor 204 includes a crosshair portion 212 and a segmented portion 214 that approximates a square surrounding the crosshair portion 212. The crosshair portion 212 identifies a location on the virtual art canvas where the user can apply virtual spray paint, for example, by pressing a button on the hand-held controller. In a typical implementation, the user can change the cursor's position by moving the hand-held controller 104 up, down, right or left or by changing the angle of the hand-held controller 104.

The size of the square represented by the segmented portion 214 of the movable cursor 204 indicates the thickness of the spray pattern that the user can apply. The size of the square and, therefore, the thickness of the spray pattern, can be changed by moving the hand-held controller 104 closer to or away from the position sensor 112. Moving the hand-held controller 104 closer to the position sensor 112 causes the square and, therefore, the thickness of the spray pattern to become smaller; whereas moving the hand-held controller 104 away from the position sensor 112 causes the square and, therefore, the thickness of the spray pattern to become wider.

In some implementations, the movements that the user makes in order to adjust the size and position of the cursor are scaled relative to the movements that are appearing on the screen to give the user a substantially realistic impression of what it would be like to create graffiti-style art work, such as is appearing on the screen, on a large wall or other surface. If, for example, the screen of a user interface is 27.5 inches wide by 15.5 inches high but the virtual canvas is intended to represent a wall approximately 7 feet wide and 5 feet high, then the scaling would be adapted so that the user's movements of the controller are similar to those that would be required to paint a 7 foot by 5 foot surface rather than a 27.5 inch by 15.5 inch wall.

It should be understood that various scaling schemes can be implemented to give the user a realistic impression of what it is like to create art on various sizes of surfaces. For example, in various implementations, the scaling can give the impression of creating art on a canvas that is 10%, 25%, 50%, 75%, 100%, 200%, 300%, 400%, 500%, 100% or more of the screen size at the user interface 104. Other scaling possibilities exist as well.

In the illustrated implementation, the guidance indicators 210a-210f and the spray paint can icon 206 provide guidance to the user to create a copy of existing art work.

The guidance indicators 210a-210f identify a pattern that the user can follow in applying the virtual spray paint in a connect-the-dots fashion. This enables the user to begin creating a copy of existing piece of art work. As the user successfully applies virtual paint to areas of the virtual canvas that correspond to the illustrated guidance indicators 210-210f, additional guidance indicators are revealed at the user interface screen in a piecemeal fashion. Therefore, by the time the user has applied spray paint corresponding to guidance indicators 210a-210f, a new set of guidance indicators, corresponding to a subsequent section of the art work will have been revealed. In the illustrated example, only a very small number of guidance indicators 210a-210f are shown. These represent only a small part of the what the user eventually will create.

In the illustrated example, guidance indicator 210a looks more prominent than the others. This indicates that guidance indicator 210a is the first indicator in the series. The relative prominence of indicator 210a illustrates to the user that the user should apply virtual paint to indicator 210a before the other illustrated indicators. In a typical implementation, the first guidance indicator (e.g., 210a) is a series is a different color than the other indicators. In some implementations, all of the subsequent indicators 210b-210f in the series appear progressively less prominent than its predecessor. Moreover, these subsequent indicators 210b-210f can be the same color as one another.

Once the user applies virtual paint to an area of the canvas that corresponds to the first guidance indicator (e.g., 210a), that guidance indicator (210a) disappears, the next guidance indicator in the series (e.g., 210b in FIG. 2) takes on one or more characteristics (e.g., size, color, brightness, etc.) that make it appear more prominent than it appeared previously, and a new guidance indicator (not visible in FIG. 2) reveals itself at the end of the series. Therefore, at any given time, until the user approaches the end of a particular segment in the art work (when no more guidance indicators would be available), six guidance indicators are present on the virtual canvas. Of course, the system may be adapted so that a different number of guidance indicators (e.g., more or less than 6) are visible at any time.

To begin create a copy of the existing art work, the user can apply virtual spray paint to the virtual canvas in a pattern that substantially follows the illustrated guidance indicators.

The spray paint icon 206 in the upper right corner of the screen also provides some guidance to the user in creating a copy of the virtual artwork. The illustrated icon 206 appears as a profile view of a spray paint can 216 with a spray paint pattern 218 extending from the can's nozzle toward the left. The width of the spray paint pattern 218 generally increases as the distance from the can's nozzle increases. Within the spray paint pattern 218 there is a dark band surrounded by two lighter colored bands. This dark band approximates the ideal paint thickness that the user should be attempting to apply to the virtual canvas at the particular guidance indicator (e.g., 201a in the illustrated embodiment) being considered.

A movable indicator 220 appears over the spray paint pattern and can move right or left over the spray paint pattern depending respectively on how close to or far from the motion sensor 112 the user positions the hand held controller 110. The side-to-side position of the movable indicator 220 indicates the width of the spray paint pattern that would be applied to the virtual canvas if the user were applying paint to the virtual canvas with the controller 110 positioned at that distance from the motion sensor 112.

The narrow dark band between the two lighter bands in the spray paint pattern represents to the user the ideal spray pattern thickness for the section of the piece being created at any given time. As the user moves through the art work, the ideal spray pattern thickness can change and as it does, so too does the position of the dark band within the spray paint pattern.

As the user proceeds with creating the piece of art work, he or she can move the controller closer to or away from the position sensor to cause the indicator 220 to align as closely as possible with the dark band in the paint spray pattern 218 to achieve an appropriate spray pattern thickness for the section of the work being created.

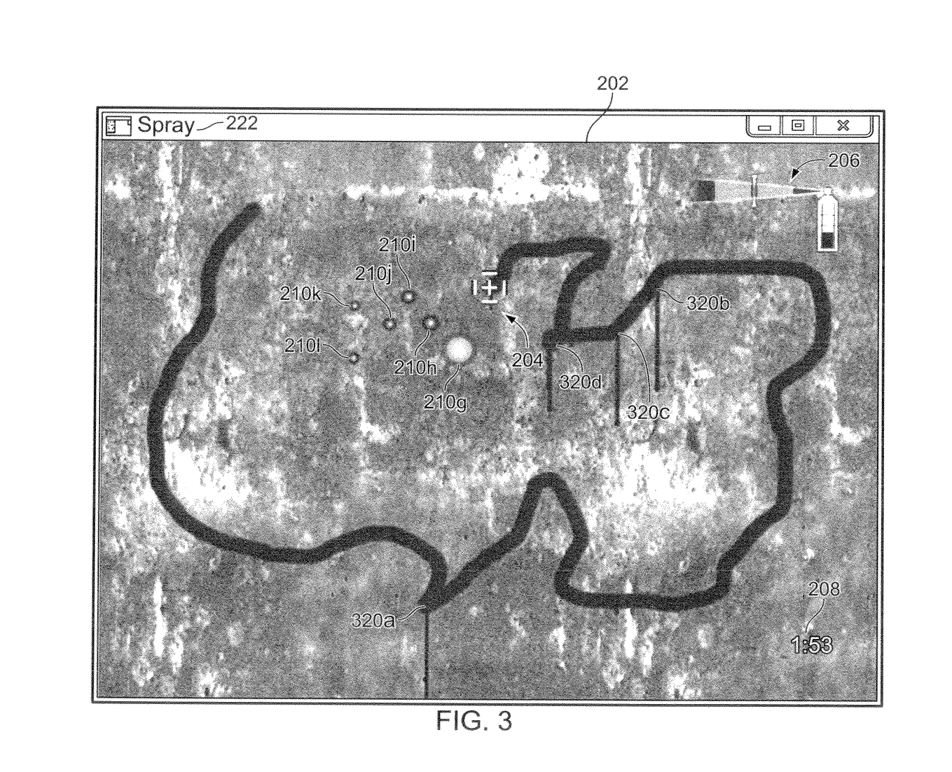

In a typical implementation, as paint is sprayed onto the virtual art canvas, the amount of pigment being delivered with the paint gradually becomes depleted. The illustrated spray paint can icon 206 provides a visual indication of the degree to which the virtual pigment has become depleted. In FIG. 2, the spray paint can 216 is almost completely filled-in with dark coloring suggesting that the supply of virtual spray paint is abundant. As the user applies the virtual spray paint to the virtual art canvas, however, the amount of dark coloring in the spray paint can 216 progressively decreases. Referring for a moment to FIG. 3, less than half of the spray paint can is darkened, indicating that the amount of pigment available for delivery with the spray paint is less than half its full capacity.

In a typical embodiment, the amount of pigment available for delivery with the spray paint can be replenished by shaking the hand-held controller 110 in much the same manner that you would a real spray paint can. As the controller 110 is shaken, which can be sensed by an accelerometer in the controller 110, the amount of pigment available for delivery increases and this is reflected by the amount of dark coloring in the spray paint can portion of icon 206 increasing.

In some implementations, the controller 110 includes a built-in speaker assembly that is adapted to create the sound of a ball balling moving about inside a can of spray paint when the controller is being shaken.

Typically, if the supply of virtual paint is not replenished and the user attempts to continue applying paint, eventually, the supply of virtual pigment will be completely exhausted. At that point, the spray paint can icon will appear completely white and further attempts to apply paint will be fruitless. In some implementations, when the supply of virtual paint has been exhausted (or substantially exhausted), the speaker in controller 110 will create the sound of an exhausted spray paint can trying to continue spraying.

In a typical implementation, the timer 208 that appears in the lower right hand corner of the virtual canvas of FIG. 2 can be used to measure how long it takes the user to create the entire work of art or various sections of the work of art.

The screenshot 202 also includes an indicator 222 showing what type of virtual art medium the system is set to apply to the virtual canvas. In the illustrated implementation, this indicator includes the word “spray” and a corresponding icon and appears in the upper left corner of the screen. There are a variety of different virtual art mediums that the system may be adapted to apply. These include: brushed paint, rolled paint, crayon, marker, pen, pencil, etc. Depending on which medium the system is set to apply at any given time, the indicator 222 can change.

FIG. 3 shows the virtual art canvas of FIG. 2, but with the first stage of the art work at a more complete stage than in FIG. 1.

As illustrated, a trail of virtual paint has been applied to the virtual canvas to create the pattern shown. The cursor 204 is at the end of the pattern. A sequence of guidance indicators 210g-2101 extends from the end of the pattern to show where the paint should be applied next.

Virtual paint drippings 320a-320d appear at different points along the applied virtual paint pattern. Typically, virtual paint drippings can appear by virtue of the user's movements and manipulations of the hand held controller 110. In one implementation, a virtual paint dripping will appear on the virtual canvas if the user applies virtual paint to a particular place for more than a pre-determined period of time. As an example, if a user continues applying paint to a particular spot on the canvas without substantially moving the controller for 3 seconds, a paint dripping may appear. Moreover, the paint dripping could become more intense (e.g., thicker, longer, etc.) if the user continues applying paint to the spot after the dripping appears. The amount of time required for a paint dripping to appear can vary and may be, for example, one second, two seconds, three seconds, four seconds, five seconds or more.

Moreover, there may be a number of other considerations that factor into determining when a paint dripping appears. These other factors can include the thickness of the spray pattern being applied, the type of paint being simulated, etc.

In a typical implementation, the art work is created in a series of discrete stages, where each discrete stage corresponds to a particular aspect of the virtual piece of art work. So, for example, in a first stage, a user may follow the guidance indicators to create an outline of some graphic. In a subsequent stage, the user might be guided (or might not be guided—and instead use free-hand) to fill-in the outlined area with color. In another subsequent stage, the user may create an outline of a sub-feature within the colored portion and so on.

In some implementations, upon completion of each discrete stage, the system presents a visual representation of the completed stages to date on the virtual canvas. In some implementations, the quality of the appearance of each visual representation of a completed stage corresponds to an assessed quality of the markings (e.g., lines, dots, fill-ins, etc.) that the user applied to create those markings. The quality assessment may be based on the user's speed and accuracy.

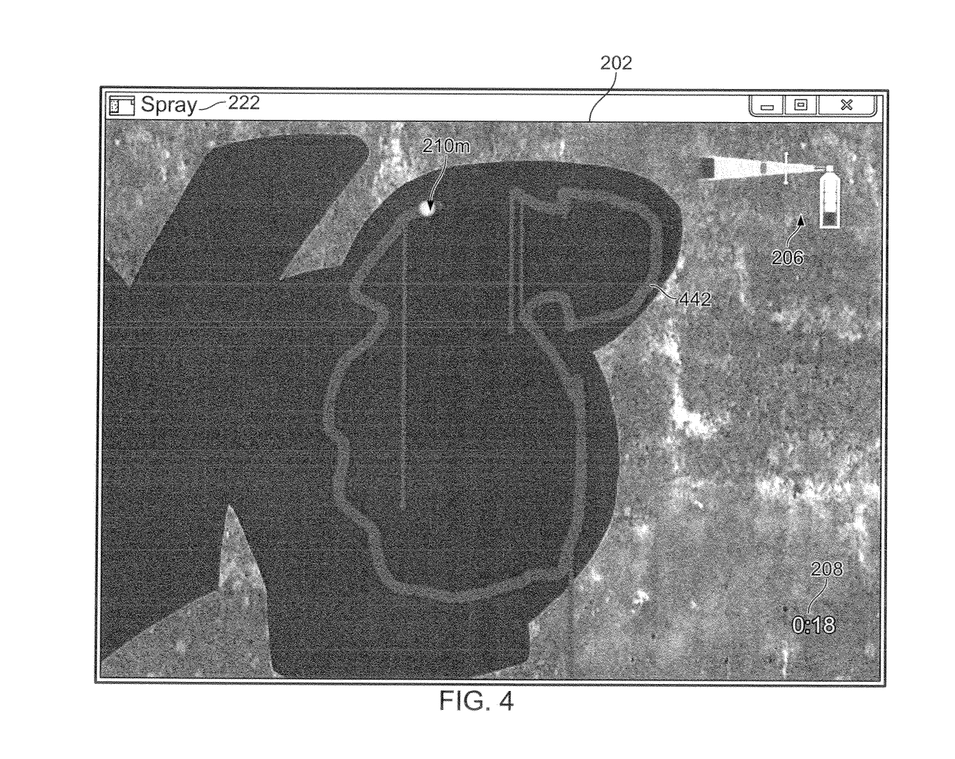

FIG. 4 shows a portion of a completed stage 440 of a piece of art work. The completed stage 440 includes an outline of the art work with an inner section that has been filled in with color. An interior line 442 of spray paint is within the confines of the outline to partially form a subsequent stage of the art work, which, in the illustrated implementation, will be an outline of a sub-feature of the art work that will appear inside the outer, filled-in outline.

Only one guidance indicator 210m is visible in FIG. 4. This indicates that no more guidance indicators are required for the user to complete the stage of the art work being worked on.

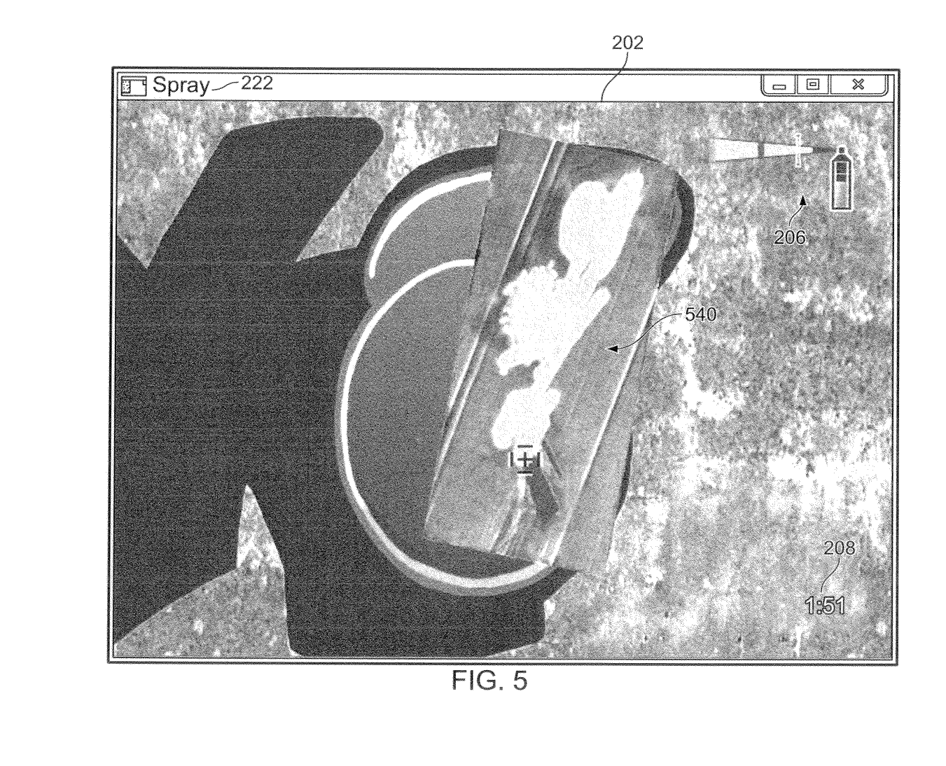

FIG. 5 shows a virtual stencil 540 being used to apply a decorative feature to the art work. In a typical implementation, the virtual stencil 540 would appear and the user would be able to apply virtual paint to the canvas through openings in the virtual stencil. In some implementations, the virtual stencil appears automatically. In some implementations, the user can select a virtual stencil from a collection of available stencils. In other implementations, the user can create a customized virtual stencil on his or her own.

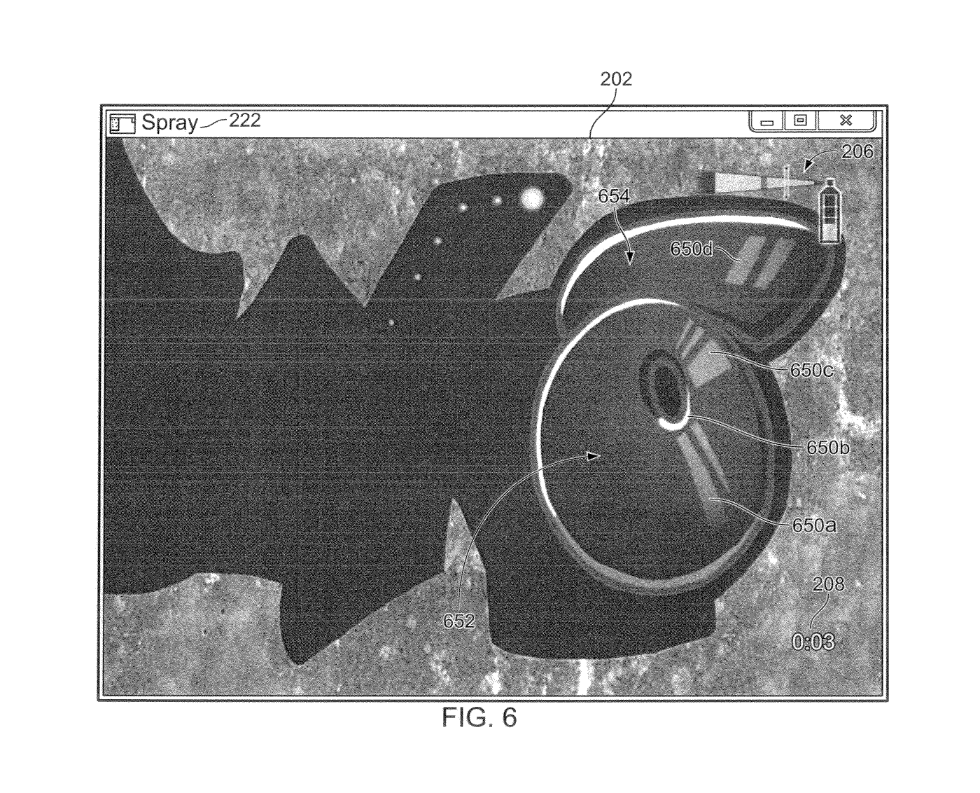

FIG. 6 shows an example of what the system would present at the user interface once the user completes the sub-feature stage that is being created in FIGS. 5 and 6.

More particularly, the screen of FIG. 6 shows a visual representation of the completed stages to date (i.e., the filled-in outer outline and the sub-feature discussed above (i.e., the letter “O” 652 with a line 654 above it) on the virtual canvas. In the illustrated example, the quality of the appearance of the “O” plus line sub-portion is very high, which typically would be indicative of a high quality of the markings (e.g., lines, dots, fill-ins, etc.) that the user applied to create this sub-portion.

Reflection markings 650a-650d appear at various places on the letter “o” and the line above the letter “o” to give these characters the appearance of depth. In a typical implementation, the virtual stencil 540 is used to apply these reflection markings 650a-650d.

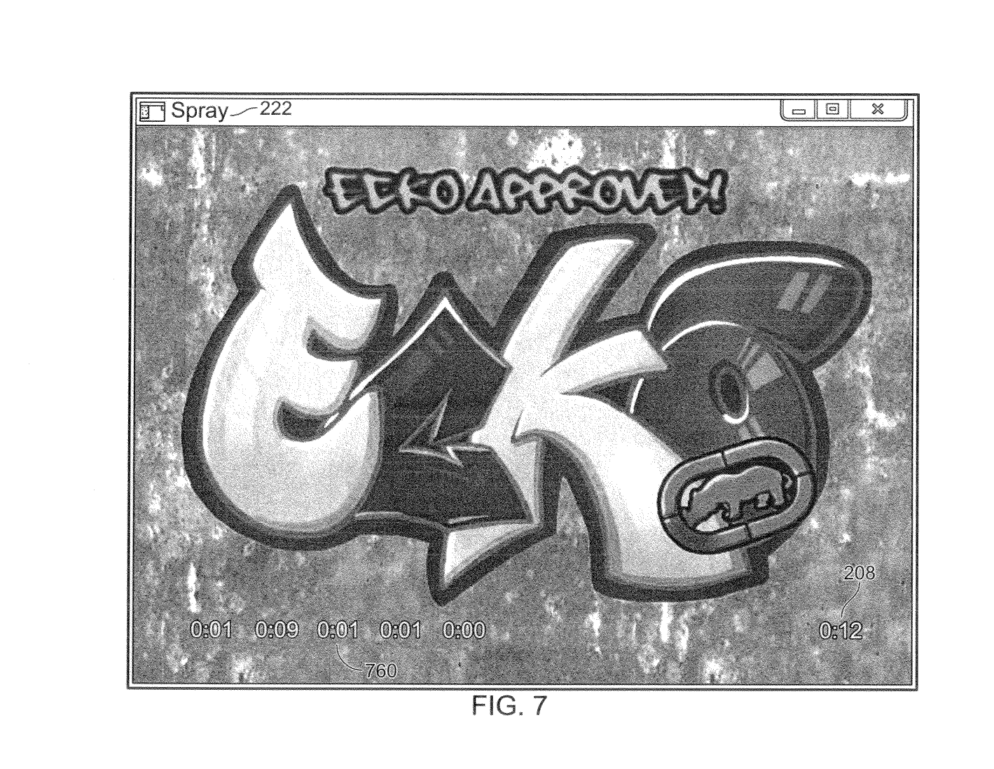

FIG. 7 shows an example of a completed piece of art work. The illustrated art work is a graffiti-style representation of “ECKO” in large letters and “ECKO APPROVED” in smaller letters above “ECKO.” Also, appearing is a rhino trademark logo of Marc Ecko, Ltd.

A series of times 760 appear across a lower left portion of the screen. In a typical implementation, these times indicate how long it took the user to create various parts of the art work.

In a typical implementation, the system assesses the quality of and speed with which the user creates a copy of an existing piece of art work. In general, the user will receive a score that depends on the degree of accuracy and speed with which the copy was created. In this way, different users can compete with each other directly or over the internet.

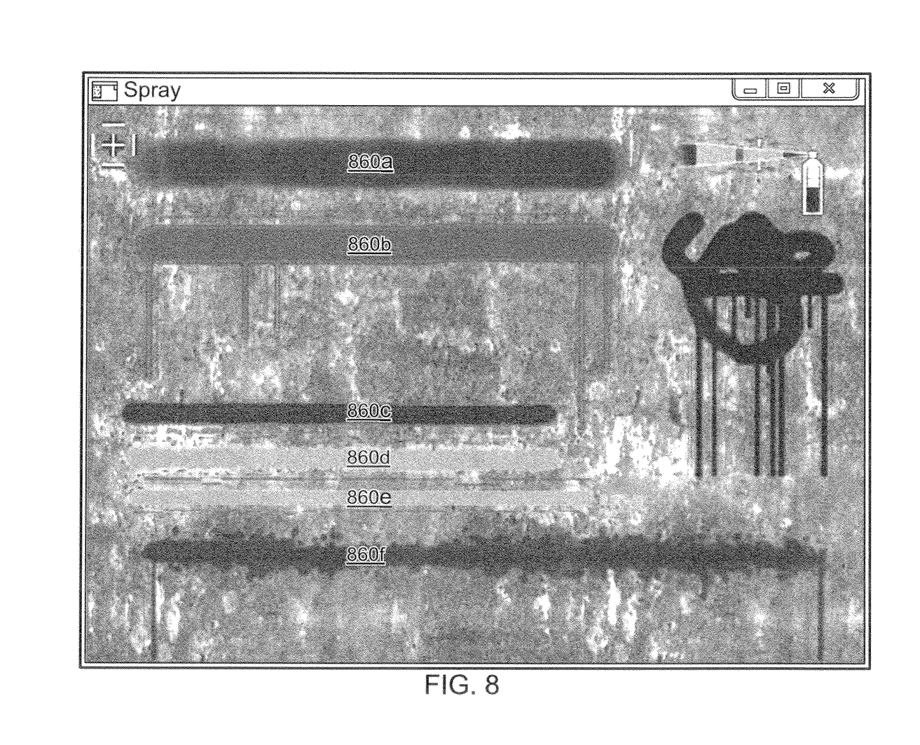

FIG. 8 illustrates a virtual art canvas with various free-hand markings formed thereon. The term “free hand” is used to indicate that the system does not provide guidance indicators or the like and that the user can create art in any style or way desired.

The illustrated markings include lines 860a-860f having different degrees of thickness. Lines 860b and 860f have virtual paint drippings. Lines 860d and 860f have edges that are less clearly defined than lines 860a-c and 860e.

Also shown is a random design 862 with paint drippings as well. In a typical implementation, if virtual paint is applied to a particular point on the virtual canvas in a sufficiently small volume that a paint dripping is not produced, but more paint is subsequently added to the same point on the canvas, then the system may consider the total amount of virtual paint that gets applied to the point during both applications and, if appropriate, produce a paint dripping after the second application. Moreover, in some instances, the system considers how much time has elapsed between the two applications to determine whether to produce a virtual paint dripping.

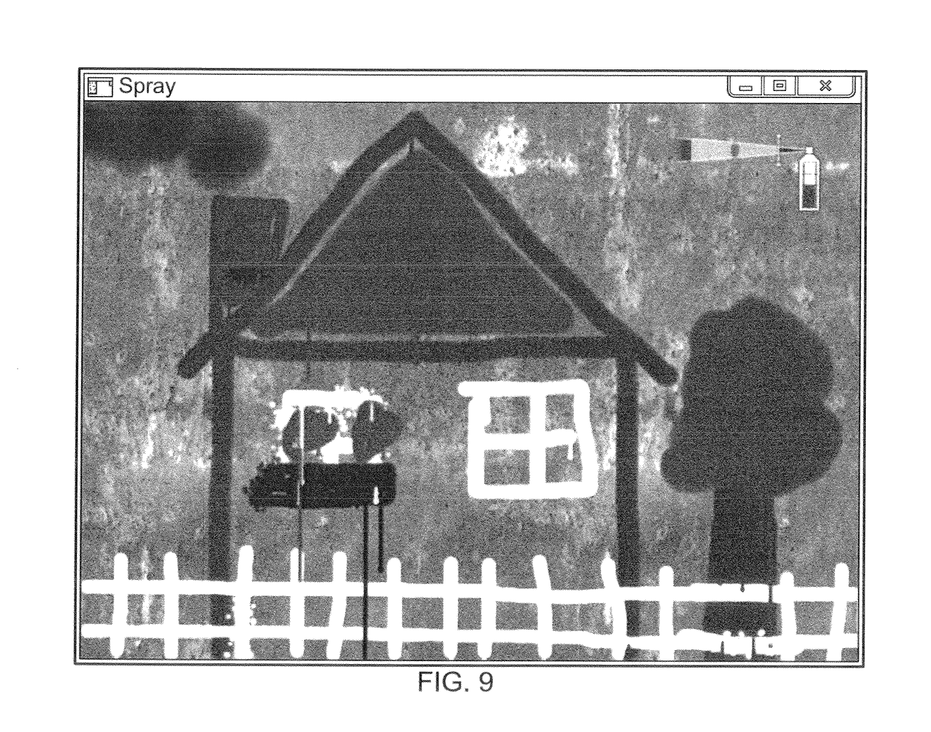

FIG. 9 shows a virtual canvas with an example of a piece of art work that could be produced by a user without guidance from the system. Depending on the skill of the user, virtually any design could be produced.

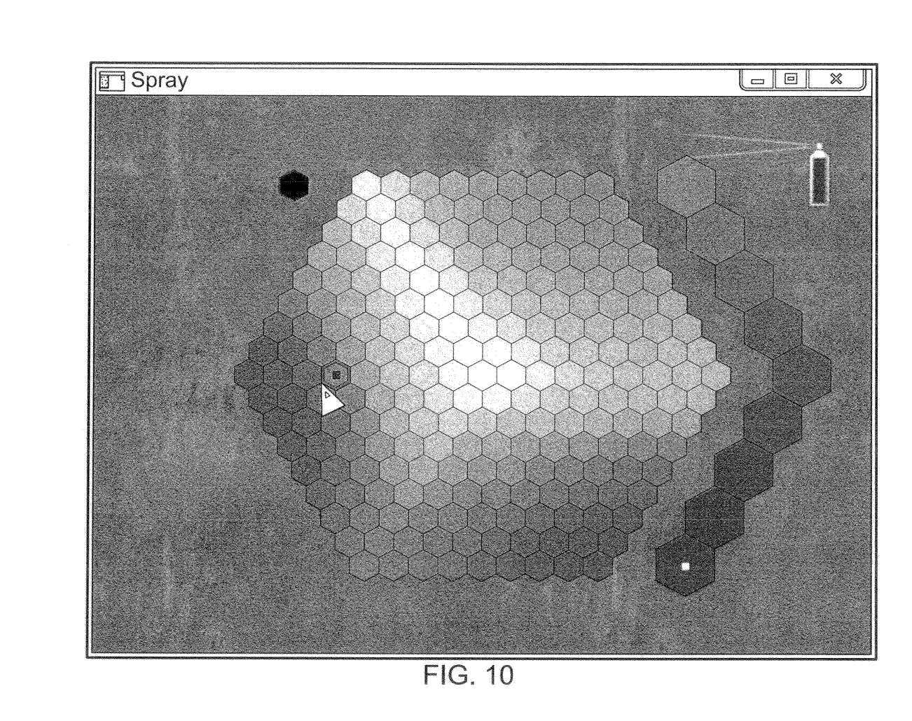

FIG. 10 shows a virtual color palate that the user can access to select the color of virtual paint to apply to the canvas. In a typical implementation, the virtual color palate is accessible whether the user is creating art in guided-mode or in free-hand mode.

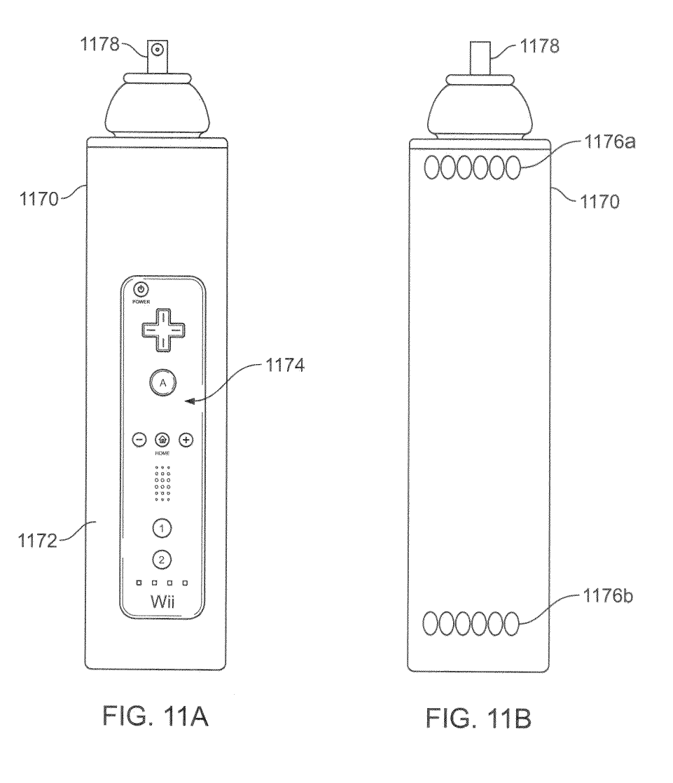

FIGS. 11A and 11B are front and rear views of an exemplary hand-held controller 110 that includes a housing portion 1170 with an opening 1172 sized to receive a remote control device 1174 for Nintendo's Wii™ system.

There are two sets 1176a, 1176b of light emitting diodes (LEDs) attached to an outer surface of the housing portion 1170 and arranged so that they can face the position sensor 112 when the controller 110 is held by a user. In the illustrated implementation, each set 1176a and 1176b of LEDs has six LEDs. The LEDs are adapted and arranged to emit light that can be detected by the position sensor 112. For example, in a particular implementation, the LEDs are adapted to emit infrared light.

The housing portion 1170 is designed to look and feel like a can of spray paint. An activation button 1178 extends upward from the can and can be depressed to cause the application of virtual art medium (e.g., virtual spray paint) onto a virtual canvas. In the illustrated implementation, the activation button 1178 extends downward into the housing portion 1170 to contact the Wii remote's trigger-style “B” button.

A variety of other control buttons are available on the exposed face of the Wii remote control.

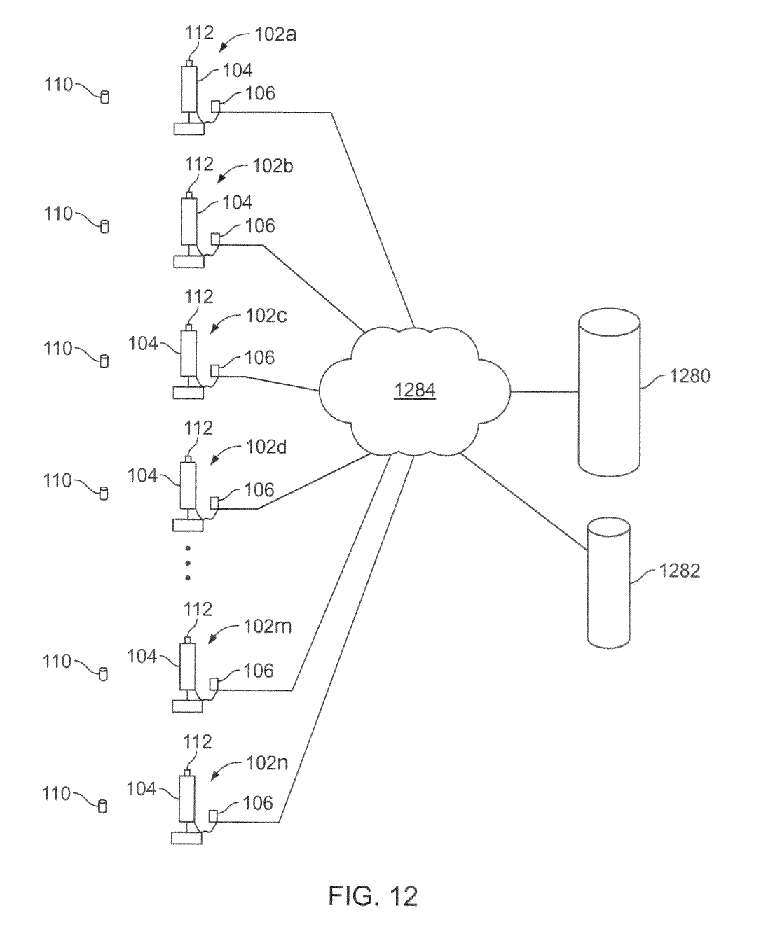

FIG. 12 is a schematic diagram showing multiple local computer systems 102a-102n, each of which could be at a different user's home, and databases 1280, 1282, connected to one another over a computer network (e.g., the Internet 1284).

Each local computer system includes a user interface 104 (e.g., a television set), a home video game console 106 connected to the user interface 104 and to the Internet 1284, a hand-held controller 110 that the user can manipulate and a position sensor 112 above the user interface for sensing the position of the controller 110.

In the illustrated implementation, each database 1280, 1282 stores a collection of art work. The art work can be licensed art work (e.g., from The Walt Disney Company or other sources of art) or original art work created by users of the system at the various local systems 102a-102n and uploaded to the databases. The art work can be available for copying (with or without guidance) or can be merely available for viewing.

In a typical implementation, the illustrated system enables users to access, from their respective local computer systems 102a-102n, a platform where they can share, compare, view, copy, download and upload art work. If, for example, a user uploads an original piece of virtual art work to one of the electronic databases 1280, 1282, then users at different physical locations can access the electronic database and view the original piece of art work.

Moreover, if the user uploads an original piece of art work, either the user can manually create or the system can automatically create a map of guidance indicators based on the original piece of virtual art work. The map of guidance indicators typically would relate to original piece of virtual art work in such a manner that the guidance indicators can guide the other users to create substantial copies of the original piece of virtual art work and be scored based on their time and/or accuracy. In cases where mapping has occurred, when other users (or the original user) select the original piece of virtual art work, the system causes the mapped indicators to be presented at the selecting user's user interface in such a manner that the selecting user can be guided by the mapped indicators to create a copy of the original piece of virtual art work on a virtual art canvas.

In a typical implementation, art work that requires a fee for downloading to copy is stored in one database (e.g., 1280) and free art work (e.g., certain user-created art work) is stored in the other database (e.g., 1281).

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A computer-based method comprising:
presenting a first virtual art canvas at a user interface;
receiving instructions from a remote control unit to apply one or more markings to the virtual art canvas,
wherein the one or more markings are applied according to the remote control unit's movements relative to a stationary sensor; and
displaying one or more indicators on the virtual canvas to guide a user's movement of the remote control unit to create a virtual piece of art on the first virtual art canvas based, at least in part, on movements of the remote control unit.

2. The computer-based method of claim 1 further comprising:
requiring the user to manipulate the remote control unit in a manner that mimics the movements that would be required if the user were applying non-virtual art medium to a non-virtual art canvas to create a non-virtual piece of art that corresponds to the virtual piece of art.

3. The computer-based method of claim 1 further comprising:
revealing discrete sections of the one or more indicators in a sequential manner as one or more of the markings are applied to the virtual canvas at locations that correspond to one or more of the previously-revealed indicators.

4. The computer-based method of claim 1 further comprising:
automatically assessing, with a computer processing unit, a quality of the one or more markings applied to the virtual canvas based on one or more of the following criteria:
how closely the movements of the remote control and application of the one or more markings correspond to the one or more indicators; and
how quickly the applied markings have been applied; and
presenting an indication of the assessed quality at the user interface.

5. The computer-based method of claim 1 wherein the one or more indicators are revealed on the virtual canvas in a manner that guides the user to create the virtual piece of art work in a series of discrete stages,
wherein each discrete stage corresponds to a particular aspect of the virtual piece of art work.

6. The computer-based method of claim 5 wherein, upon completion of each discrete stage, a visual representation of the completed stages is presented on the virtual canvas, and
wherein the physical appearance of each visually represented stage corresponds to an assessed quality of the applied markings in the stage.

7. The computer-based method of claim 1 wherein a virtual medium is used to apply the one or more markings and wherein a supply of the virtual medium gradually becomes depleted or otherwise compromised as the one or more markings are applied.

8. The computer-based method of claim 7 further comprising:
enabling a user to replenish or otherwise restore the supply of virtual medium by manipulating the remote control unit so that markings can continue being applied to the virtual canvas.

9. The computer-based method of claim 7 further comprising:
presenting on the user interface a real-time visual indication of the degree to which the virtual medium being applied to create the one or more markings has been depleted or otherwise compromised.

10. The computer-based method of claim 1 further comprising:
storing one or more virtual pieces of art in an electronic database; and
enabling the user to access the electronic database over a network and to select among the stored virtual pieces of art one of the virtual pieces of art to create.

11. The computer-based method of claim 1 wherein the remote control unit is shaped substantially like a spray paint can and has a nozzle at a top of the can that can be depressed to apply the one or more markings to the virtual canvas as a virtual spray paint.

12. The computer-based method of claim 11 wherein a spray pattern thickness associated with the one or more markings is related to the remote control unit's distance from the stationary sensor as the one or more markings are being applied to the virtual canvas, wherein
a greater distance produces a wider pattern; and
a closer distance produces a narrower pattern.

13. The computer-based method of claim 11 further comprising:
creating an appearance of dripping paint on the virtual canvas in response to a user applying an amount of the virtual spray paint to a location on the virtual canvas that exceeds a predetermined threshold amount.

14. The computer-based method of claim 1 further comprising:
presenting a second virtual art canvas at the user interface;
receiving instructions from the remote control unit to apply one or more markings to the second virtual art canvas, wherein the one or more markings are applied according to the remote control unit's movements relative to the stationary sensor; and
enabling the user to create an original piece of virtual art work without the guidance of indicators being displayed on the second virtual canvas as the original piece of virtual art work is being created.

15. The computer-based method of claim 14 further comprising:
enabling the user to upload the original piece of virtual art work to an electronic database over a network; and
enabling users at different physical locations to access the electronic database and view the original piece of art work.

16. The computer-based method of claim 15 further comprising:
creating a map of indicators based on the original piece of virtual art work,
wherein the map of indicators relate to original piece of virtual art work in such a manner that the indicators can guide other users to create substantial copies of the original piece of virtual art work.

17. The computer-based method of claim 16 further comprising:
enabling users at different physical locations to access the electronic database and select the original piece of art work from the electronic database,
wherein selecting the original piece of virtual art work causes the mapped indicators to be presented at the a selecting user's user interface in such a manner that the selecting user is guided by the mapped indicators to create a copy of the original piece of virtual art work on a virtual art canvas.

18. A computer-based method comprising:
presenting a virtual art canvas at a user interface;
receiving instructions from a remote control unit to apply one or more markings to the virtual art canvas and thereby create an original piece of virtual art work on the virtual art canvas,
wherein the one or more markings are applied according to the remote control unit's movements relative to a stationary sensor;
creating a map of indicators based on the original piece of virtual art work; and
enabling users at different physical locations to be guided by the mapped indicators to create a copy of the original piece of virtual art work.
